(19) United States
(12) Patent Application Publication
(10) Pub. No.: US 2010/0206105 A1
(43) Pub. Date: Aug. 19, 2010

(54) DUAL CLUTCH TRANSMISSION

(75) Inventor: Wolfgang Rieger, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/681,912

(22) PCT Filed: Oct. 8, 2008
(86) PCT No.: PCT/EP08/63429

§ 371 Date: Apr. 7, 2010

(30) Foreign Application Priority Data
Oct. 15, 2007 (DE) 10 2007 049 269.5

(51) Int. Cl. F16H 3/16

(52) U.S. Cl. 74/331

(57) ABSTRACT

A double clutch transmission with two clutches connected to a drive shaft and to one of two transmission input shafts. Fixed gears are coupled to the input shafts and engage idler gears. Several coupling devices connect the idler gears to a countershaft which have an output gear that couple gears of an output shaft such that at least seven power shift forward gears and at least one reverse gear can be shifted, and four gear wheel planes are arranged in such a way that at least one power shift winding-path gear can be shifted via the shifting device, such that at least seven power shift forward gears and at least one reverse gear can be shifted, and five gear planes are positioned in such a way that at least one power shift winding-path gear can be shifted via a shifting device.

This application is a National Stage completion of PCT/EP2008/063429 filed Oct. 8, 2008, which claims priority from German patent application serial no. 10 2007 049 269.5 filed Oct. 15, 2007.

### FIELD OF THE INVENTION

The present invention relates to a double clutch transmission for a motor vehicle.

### BACKGROUND OF THE INVENTION

Known from the publication DE 103 05 241 A1 is a 6-speed or 7-speed dual clutch transmission. The dual clutch transmission comprises two clutches, each connected with their inputs to the drive shaft and their output to one of the two transmission input shafts. The two transmission input shafts are coaxially arranged towards each other. In addition, two countershafts are positioned to be axially parallel to the transmission input shafts, their idler gear wheels mesh with the fixed gear wheels of the transmission input shafts. Furthermore, coupling devices that are axial movable, are supported on the countershaft and connected to shift the respective gear wheels in a rotationally fixed manner. Each selected ratio is transferred by the drive gear wheels to a differential transmission. To achieve the desired gear ratio steps in this known double clutch transmission, a vast number of gear planes are required, so that a significant amount of installation space is needed.

In addition, a spur gear change speed transmission is known through the publication DE 38 22 330 A1. The spur gear change speed transmission comprises a double clutch, that is power shiftable, where one part is connected with a drive shaft and the other part with a hollow drive shaft, rotatabley supported on the drive shaft. For certain gear ratios, the drive shaft can be coupled with the hollow drive shaft via a shifting device.

Known from the publication DE 10 2004 001 961 A1 is a power transmission with two clutches, each of which are assigned to a partial transmission. The transmission input shafts of the two partial transmissions are coaxially positioned with respect to each other and mesh, via fixed gear wheels, with idler gear wheels of the designated countershaft. The respective idler gear wheels of the countershafts can be connected, in a rotationally fixed manner, with the respective countershaft via designated shifting devices. The particular idler gear wheels of the countershaft can be connected via the assigned shifting devices with the associated countershaft in a rotationally fixed manner. A double clutch transmission is known from this publication, which absolutely requires at least six gear planes. Hence, the needed spatial installation requirement, in axial direction, increases with such transmission, so that the installation options are significantly limited with such known transmission.

### SUMMARY OF THE INVENTION

It is the task of this present invention, to propose a double clutch transmission as in the previously described genus, in which the power shiftable gear ratio steps are realized with the least spatial installation requirement, secondly, the transmission shall need only few parts, hereby keeping the manufacturing cost for the transmission low.

Thus, a double clutch transmission with just five gear planes in the partial transmissions is realized, whereby the two partial transmissions can engaged as a winding path gear via at least one additional shifting device. Hereby, the proposed double clutch transmission realizes as few gear planes as possible, but providing a maximum number of transmission ratios, whereby preferably all forward gears and reverse gears are power shiftable in sequential mode.

The gear wheels of both partial transmissions are coupled with each other in a winding-path gear, to enable a flow of force through both partial transmissions. The respective shifting device which is used to couple idler gear wheels and establish a dependency between transmission input shafts. Independently of the particular embodiment of the double clutch transmission, the configuration of the shifting devices for the coupling of two particular idler gear wheels can be varied, so that the shifting element does not need to be positioned necessarily between the idler gear wheels which need to be coupled.

Because of the low number of required gear planes, a short, axial configuration length is required for the proposed transmission, which enables also a front-transverel implementation in motor vehicles. Due to the fact that the invented double clutch transmission also provides winding-path gears, and because of the three-shaft configuration, the multi-use of particular gear pairs or gear wheels, respectively, is enabled, which leads to a reduction of component parts of the transmission.

In the proposed double clutch transmission, in accordance with the invention, gear planes can be provided, as a so-called dual gear plane and/or single gear plane. In a dual gear plane, an idler gear wheel on the countershafts is each assigned to a fixed gear wheel of a transmission input shaft. To the contrary, in a single gear plane, just one idler gear wheel of a countershaft is assigned to a fixed gear wheel of a transmission input shaft. Due to the fact that in each dual gear plane one idler gear wheel can be used for at least two gears, the possible multi-use idler gear wheels enables the realization of a certain number of gear ratios with less gear planes. Hence, the physical length of the transmission can be reduced.

For the use of single gear planes, in which just one idler gear wheel of a countershaft is assigned to the fixed gear wheel of a transmission input shaft, a large range of transmission ratios is possible.

The winding-path gears can be realized through several gear pairs or gear planes, respectively, so that additional gears can be shifted via the particular gear pairs or gear planes, respectively of the winding-path gears.

The proposed gear planes, in accordance with the invented double clutch transmission, provide a gear set configuration to obtain at least seven forward gears and at least one reverse gear ratio, whereby at least one winding-path gear can be realized in the first gear step and/or in the reverse gear ratio. Also additional winding-path gears can the engaged as second up to the seventh gear, or also as reverse gears, whereby the seventh gear, depending on the sixth gear, can be power shifted. All forward gears and reverse gears should be, in a sequential embodiment, power shiftable. Non-power shiftable winding-path gears can be configured as intermediate gears, in which the transmission takes place between the ratios of two main drive gears, as overdrive gears or speed gears in which the gear ratio is in each case smaller as the smallest gear ratio of the main drive gear (6^{th} gear), as off-road gear or low speed gear in which the gear ratio in each case is larger than the gear ratio of the first gear, and/or as additional reverse gears.

The power shiftable reverse gears, in the invented double clutch transmission, are realized through just one additional engagement or through just one additional gear wheel and at least, through the additional gear plane, which reverses the rotation, a reverse gear can be realized as a winding-path gear, and another reverse gear can be realized directly via the gear plane. The gear ratios of the reverse gears can, for instance, be varied by adding an additional step gear or similar.

Within the scope of an embodiment of this invention, it can be provided that the five gear planes are realized, as an example, through seven gear pairs. For instance, at least three fixed gear wheels can be supported on the first transmission input shaft and at least two fixed gear wheels can be supported on the second transmission input shaft, which mesh, for instance, with five idler gear wheels on the first, and at least two idler gear wheels on the second countershaft. Also, other constructive embodiments are possible to realize the four gear planes.

The additional shifting device for coupling the partial transmission can, for instance, be positioned on the first countershaft, as an example, between the second and the third gear planes.

Hence, in this embodiment of the invented double clutch transmission, at least seven power shiftable forward gears and two reverse gears are realized, whereby at least the first gear, and one of the reverse gears, can be configured as a winding-path gear. The first reverse gear is shifted via the same clutch as the first gear. The gears with a high load, like for instance the first and second forward gears, and the first and second reverse gears, provide the output through the second countershaft. The winding-path gears can be realized in this embodiment as forward, as well as backward, via the same gear pairs.

A following embodiment can realize the five gear planes through eight gear pairs, the five fixed gear wheels mesh with five idler gear wheels and three idler gear wheels on the second countershaft. This gear set configuration enables a progressive gear steps and three reverse gears, whereby the first reverse gear is designed as a winding-path gear, and the second reverse gear is power shiftable, in relationship to the first reverse gear. The additional reverse gear is again power shiftable in relationship to the first forward gear.

In an additional embodiment of the inventive double clutch transmission, the five gear planes are also realized through eight gear pairs, whereby and additional, second shifting device is provided on the second countershaft. This gear set configuration also enables progressive gear steps, whereby the first forward gear and the reverse gear are designed as winding-path gears. The second countershaft can be used for low load gears six and seven, and for the gear pair of the winding path-gear in the first gear.

To connect the idler gear wheels, for the different gear ratio steps, in a rotationally fixed manner with the respective countershaft, in this example, several dual action coupling devices are positioned on the first countershaft, whereby also, in addition, at least a single action coupling device can be positioned at the first coupling device. On the second countershaft, at least a dual action coupling device and/or at least a single action coupling device can be positioned. Coupling devices can be, for instance, hydraulically operated clutches or also interlocking claw clutches, as well as any kind of synchronization device.

The additional shifting device to couple the partial transmissions can, for instance, be positioned on the first countershaft, but also on the second countershaft, for instance between the second and third gear planes. In addition, also a second, additional shifting device can be positioned on the respective other countershaft. Other configurations are also possible by use of additional shifting devices. Thus, the coupling of the two transmission input shafts takes place through a shifting devices via gear meshing, so that the transmission input shafts become interconnected.

It is also possible to vary the presented configuration options and also to vary the number of gear wheels, and the number of coupling devices, to realize additional load or non-load shiftable gears, reduction and installation space and part reduction for the proposed double clutch transmission. In addition, the respective configuration of the coupling devices in the gear plane can be varied. Also, the operating direction of the coupling devices can be varied or extended, respectively. It is also possible that a dual action coupling device can be replaced by two single action coupling devices, and vice versa.

Independent from the particular embodiment of the double clutch transmission, the drive shaft and the output shaft, preferably, do not need to be positioned coaxially to each other, which realizes especially an installation space saving configuration. For instance, shafts, which are spatially positioned one after the other, can also be a slightly offset from each other. In that configuration, a direct gear with the transmission ratio of one can be realized via gear meshing, and can, in an advantageous way, be relatively freely shifted to the fifth, the sixth, or the seventh gear. Other configurations of the drive shaft and the output shaft are also possible.

The proposed double clutch transmission is preferably equipped with an integrated output stage. The output stage can comprise, as an output gear, a fixed gear wheel on the output shaft, which meshes with a fixed gear wheel of the first countershaft, a fixed gear wheel of the second countershaft.

Advantageously, the lower forward gears and the reverse gears can be activated through a starting, or shifting clutch, respectively, to hereby concentrate higher loads on this clutch and to construct the second clutch with less need for installation space and as more cost-effective. Especially, the gear planes in the proposed double clutch transmission can be positioned in a way that one can start, through the inner transmission input shaft or the outer transmission input shaft, hereby always a starting through the more appropriate clutch, which is also possible in a concentrically positioned, radially nested construction of the double clutch. Hereby and accordingly, the gear planes can be positioned as mirror-symmetric, or swapped, respectively. It is also possible the countershafts are swapped or positioned as in a mirror image.

### BRIEF DESCRIPTION OF THE DRAWINGS

Following, the present invention is further explained based on the drawings. It shows:

FIGS. 1 and 1A a schematic view of the first embodiment of a 7-gear double clutch transmission with an exemplary shifting scheme;

FIGS. 2 and 2A a schematic view of a second embodiment of the inventive 7-gear double clutch transmission with an exemplary shifting scheme; and

FIGS. 3 and 3A a schematic view of a third embodiment of the inventive 7-gear double clutch transmission with an exemplary shifting scheme.

### DETAILED DESCRIPTION OF THE PREFERRED EMBODIMENTS

An inventive 7-gear double clutch transmission comprises two clutches K1, K2, the input sides of which are connected to a drive shaft w_an. Also, a torsion vibration damper 17 can be mounted on the drive shaft w_an. The output sides of the clutches K1, K2 are each connected with one of two, coaxially positioned, transmission input shafts w_K1, w_K2. The first transmission input shaft w_K1 is designed as a solid shaft and the second transmission input shaft w_K2 is designed as hollow shaft. In addition, countershafts w_vorlege1, w_vorgelege2 are provided which are positioned axially parallel to each other. The coupling of the two transmission input shaft w_K1 and w_K2 takes place through a shifting device L and M via tooth meshing, so that the transmission input shafts w_K1 and w_K2 are interconnected.

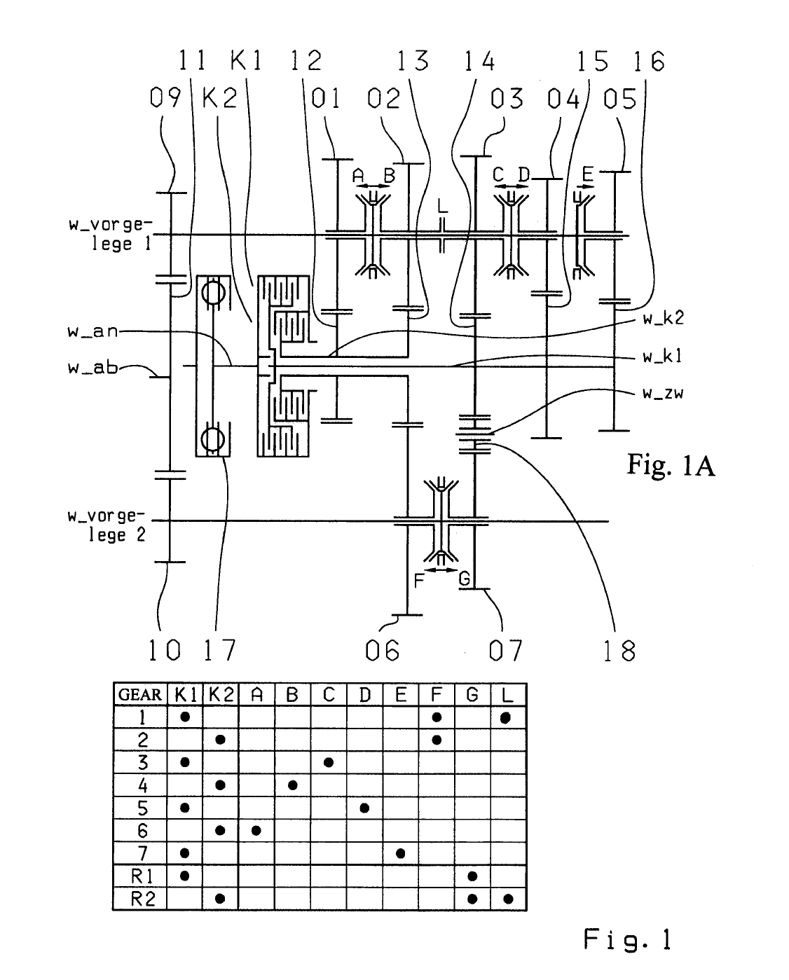

Five gear planes are provided for the inventive 7-gear double clutch transmission. In the first embodiment, in accordance with FIG. 1, the five gear planes 01-12, 02-06, 03-07, 04-15, 05-16 are realized through two fixed gear wheels 12, 13 on the second transmission input shaft w_K2 and through three fixed gear wheels 14, 15, 16 on the first transmission input shaft w_K1, which mesh with five idler gear wheels 01, 02, 03, 04, 05 on the first countershaft w_vorgelege1 and with two idler gear wheels 06, 07 on the second countershaft w_vorgelege 2.

In the embodiment , in accordance with FIG. 1, the second gear plane 02-06 and the third gear plane 03-07 are each designed as dual gear planes. In contrast, the first gear plane 03-12, the fourth gear plane 04-15, and the fifth gear plane 05-16 are each designed as single gear plane.

In the first gear plane 01-12, the fixed gear wheel 12 of the second transmission input shaft w_K2 meshes only with the idler gear wheel 01 on the first countershaft w_vorgelege 1. Hereby, the advantage of a more free transmission gear selection arises, in contrast to gear planes with dual side meshing at the fixed gear wheel.

The second gear plane 02-06 comprises the fixed gear wheel 13 on the second transmission input shaft w_K2, which meshes with the idler gear wheel 02 on the first countershaft w_vorgelege 1, as well as with the idler gear wheel 06 of the a second countershaft w_vorgelege 2.

The third gear plane 03-07 comprises the fixed gear wheel 14 on the first transmission input shaft w_K1, which meshes with the idler gear wheel 03 on the first countershaft w_vorgelege 1. Also, an idler gear wheel 18 on an intermediate shaft w_zw meshes with the fixed gear wheel 14 on the first transmission input shaft w_K1 as well as with the idler gear wheel 07 on the second countershaft w_vorgelege 2. Thus, a reversal of rotation for the realization of the reverse gears R1 and R2 can be provided. It is also possible, that the idler gear wheel 18 is designed as a step gear. To achieve the reversal of rotation, also the idler gear wheel 03 of the first countershaft w_vorgelege 1 can mesh with the idler gear wheel 07 on the second countershaft w_vorgelege 2, so that the idler gear wheel 18 can be omitted.

In the fourth gear plane 04-15, the fixed gear wheel 15 on the first transmission input shaft w_K1 meshes only with the idler gear wheel 04 on the first countershaft w_vorgelege 1. Finally, the fifth gear plane 05-16 comprises the fixed gear wheel 16 on the first transmission input shaft w_K1, which only meshes with the idler gear wheel 05 on the first countershaft w_vorgelege 1. Thus, the fixed gear wheel 15 or 16 on the first transmission input shaft w_K1, in the fourth gear plane 04-15, or the fifth gear plane 05-16 in each case only with an idler gear wheel 04 or 05 on the first countershaft w_vorgelege 1. Hereby, the advantage of a more free transmission gear selection arises, in contrast to gear planes with dual side idler gear wheel meshing at the fixed gear wheel.

For the first countershaft w_vorgelege 1, in this proposed gear set configuration, between the first gear plane 01-12 and the second gear plane 02-06 and between the third gear plane 03-07 and the fourth gear plane 04-15, dual action coupling devices A-B, C-D are provided for each. In addition, in the fifth gear plane 05-16, facing the clutches K1 and K2, a single action coupling device E is provided on the first countershaft w_vorgelege 1. On the second countershaft w_vorgelege 2, between the second gear plane 02-06 and the third gear plane 03-07, a dual action coupling device F-G is provided.

To also realize winding-path gears, meaning to enable the coupling of both partial transmissions, the additional shifting device L is positioned on the first countershaft w_vorgelege 1, between the second gear plane 02-06 and the third gear plane 03-07.

The table, which is presented in FIG. 1A, shows an exemplary shifting scheme for the first embodiment of the 7-gear dual clutch transmission.

In accordance with the shifting schemes in FIG. 1A, the first forward gear 1 is shifted via the first clutch K1 and via the, shifted the direction F, coupling device F-G, as well as via the activated shifting device L, as a winding-path gear the second forward gear 2 is shifted via the second clutch K2 and via the coupling device F-G, shifted into the direction F, whereby the third forward gear 3 is shifted via the first clutch K1 and the coupling device C-D, shifted into direction C. The fourth forward gear 4 is shifted via the second clutch K2 and the coupling device A-B, shifted into direction B, whereby the fifth forward gear 5 is shifted via the first clutch K1 and via the coupling device C-D, shifted into direction D. The sixth forward gear 6 is shifted via the second clutch K2 and via the, shifted into direction A, coupling device A-B, whereby the seventh forward gear 7 is shifted via the clutch K1 and the coupling device E of the first countershaft w_vorgelege 1. The first reverse gear R1 is shifted via the first clutch K1 and via the coupling device F-G, shifted into direction G. The second reverse gear R2 is shifted via the a second clutch K2 and via the coupling device F-G, shifted into direction G and as via the activated shifting device L as a winding-path gear.

Thus, the first forward gear 1, as a winding-path gear, uses the gear wheels 14, 03, 02, 13, 06, and 10. In the second forward gear 2, the gear wheels 13, 06, and 10 are used, whereby the gear wheels 14, 03, and 09 are used to realize the third forward gear 3. In the a fourth forward gear 4, the gear wheels 13, 02, and 09, whereby in the fifth forward gear 5 the gear wheels 15, 04, and 09 are used. The sixth forward gear 6 uses the gear wheels 12, 01, and 09. Finally, the seventh gear 7 uses the gear wheels 16, 05, and 09. In the first reverse gear R1, the gear wheels 14, 18, 07, and 10 are used. In the a second reverse gear R2, the gear wheels 13, 02, 03, 14, 18, 07, and 10 are used as a winding-path gear.

Other assignment configurations of the particular gear steps in this embodiment, in regard to the clutches, are also possible. Especially through or mirror image, for instance, a reversed assignment configuration can easily be realized.

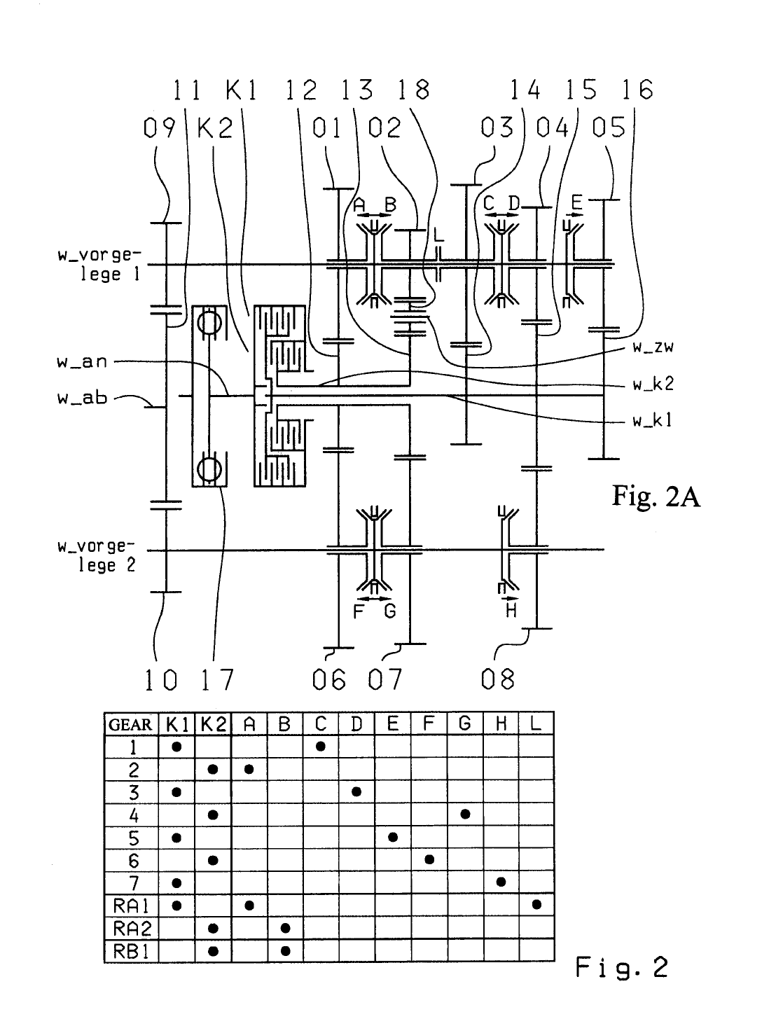

In the second embodiment, in accordance with FIG. 2, the five gear planes 01-06, 02-07, 03-14, 04-08, 05-16 are realized through two fixed gear wheels 12, 13 of the second transmission input shaft w_K2 and three fixed gear wheels 14, 15, 16, on the first transmission input shaft w_K1, which mesh with five idler gear wheels 01, 02, 03, 04, 05 on the first countershaft w_vorgelege 1 and three idler gear wheels 06, 07, 08 on the second countershaft w_vorgelege 2.

In accordance with the embodiment presented in FIG. 2, the first gear plane 01-06, the second gear plane 02-07, and the fourth gear plane 04-08, are each designed as dual gear planes. In contrary, the third gear plane 03-14 and the fifth gear plane 05-16 are designed as single gear planes.

The fixed gear wheel 12 of the second transmission input shaft w_K2 meshes in the first gear plane 01-06 with the idler gear wheel 01 of the first countershaft w_vorgelege 2, as well as with the idler gear wheel 06 of the second countershaft w_vorgelege 2.

The second gear plane 02-07 comprises the fixed gear wheel 13 of the second transmission input shaft w_K2, which meshes with the idler gear wheel 07 on the second countershaft w_vorgelege 2. In addition, an idler gear wheel 18 meshes with the fixed gear wheel 13 on the second transmission input shaft w_K2 the idler gear wheel 02 on the first countershaft w_vorgelege 1. Hereby, a reversal rotation can be realized for the reverse gears RA1, RA2, RB1. It is also possible to design the idler gear wheel 18 as a step gear. To achieve a reversal of rotation, the idler gear wheel 02 on the first countershaft w_vorgelege 1, can also mesh with the idler gear wheel 07 on the second countershaft w_vorgelege 2, so that the idler gear wheel 18 can be omitted.

The third gear plane 03-14 comprises the fixed gear wheel 14 on the first transmission input shaft w_K1, which meshes only with the idler gear wheel 03 on the first countershaft w_vorgelege 1. Hereby, the advantage of a more free transmission gear selection arises, in contrast to gear planes with dual side idler gear wheel meshing at the fixed gear wheel.

In the fourth gear plane 04-08, the fixed gear wheel on the first transmission input shaft w_K1 meshes with the idler gear wheel 04 on the first countershaft w_vorgelege 1, as well as with the idler gear wheel 08 on the second countershaft w_vorgelege 2.

Finally, the fifth gear plane 05-16 comprises the fixed gear wheel 16 on the first transmission input shaft w_K1, which meshes only with the idler gear wheel 05 on the first countershaft w_vorgelege 1. Again, the advantage of a more free transmission gear selection arises, in contrast to gear planes with dual side idler gear wheel meshing at the fixed gear wheel.

In this proposed gear set configuration, on the first countershaft w_vorgelege 1, between the first gear plane 01-06 and the second gear plane 02-07, the dual action coupling devices A-B are provided. Also, on the first countershaft w_vorgelege 1, between the third gear plane 03-14 and the fourth gear plane 04-08, the dual action coupling devices A-B, C-D, are positioned. Also, in the fifth gear plane 05-16, facing the clutches K1, K2, a single action coupling device E is provided on the first countershaft w_vorgelege 1.

On the second countershaft w_vorgelege 2, a dual action coupling device F-G is positioned between the first gear plane 01-06 and the second gear plane 02-07 gear. In addition on the second countershaft w_vorgelege 2 and on the side which faces the clutches K1, K2 of the fourth gear plane 04-08, a single action coupling device H is positioned.

To also realize winding-path gears, meaning to couple the two partial transmissions with each other, an additional shifting device L, as in the first embodiment, is positioned on the first countershaft w_vorgelege 1, between the second gear plane 02-07 and the third gear plane 03-14.

The presented table of FIG. 2A shows exemplary shifting scheme for the second embodiment of the 7-gear double clutch transmission.

In accordance with the shifting schemes in FIG. 2A, the first forward gear 1 is shifted via the first clutch K1 and via the, shifted into direction C, coupling device C-D. The second forward gear 2 is realized via the second clutch K2 and via the, shifting the coupling device A-B in the direction A, the search forward gear 3 is shifted via the first clutch K1 and via the coupling device C-D, shifted into direction D. The fourth forward gear 4 is shifted via the second clutch K2 and via the coupling device F-G, shifted into direction G, the fifth forward gear 5 is realized via the first clutch K1 and via the coupling device E of the first countershaft w_vorgelege 1. The sixth forward gear 6 is shifted via the second clutch K2 and via the coupling device F-G, shifted into direction F, the seventh forward gear 7 is again shifted via the first clutch K1 and via the coupling device H of the second countershaft w_vorgelege 2. The first reverse gear RA1 is shifted via the first clutch K1 and via the coupling device A-B, shifted into the direction A, as well as via the activated shifting device L as a winding-path gear. The second reverse gear RA2 and the alternative first reverse gear RB1 are each shifted via the second clutch K2 and via the coupling device A-B, shifted into direction B.

Thus, the first forward gear 1 uses the gear wheels 14, 03, and 09. In the second forward gear 2, the gear wheels 12, 01, and 09 are use, whereby the gear wheels 15, 04, and 09 are applied to realize the third forward gear 3. In the fourth forward gear 4, the gear wheels 13, 07, and 10 are used, whereby in the fifth forward gear 5, the gear wheels 16, 05, and 09 are used, whereby in the sixth forward gear 6, the gear wheels 12, 06, and 10 are used. Finally, the seventh forward gear uses the gear wheels 15, 08, and 10. In the first reverse gear RA1 the gear wheels 14, 03, 02, 18, 13, 12, 01, and 09 are used as winding-path gear, whereby the second reverse gear RA2 and the alternative, first reverse gear RB1 each use the gear wheels 13, 18, 02, and 09.

In this embodiment, the assignments of the particular gear steps are possible in regard to the clutches. Especially, for instance through a mirror image, a reversal of assignments can be realized in a simple way.

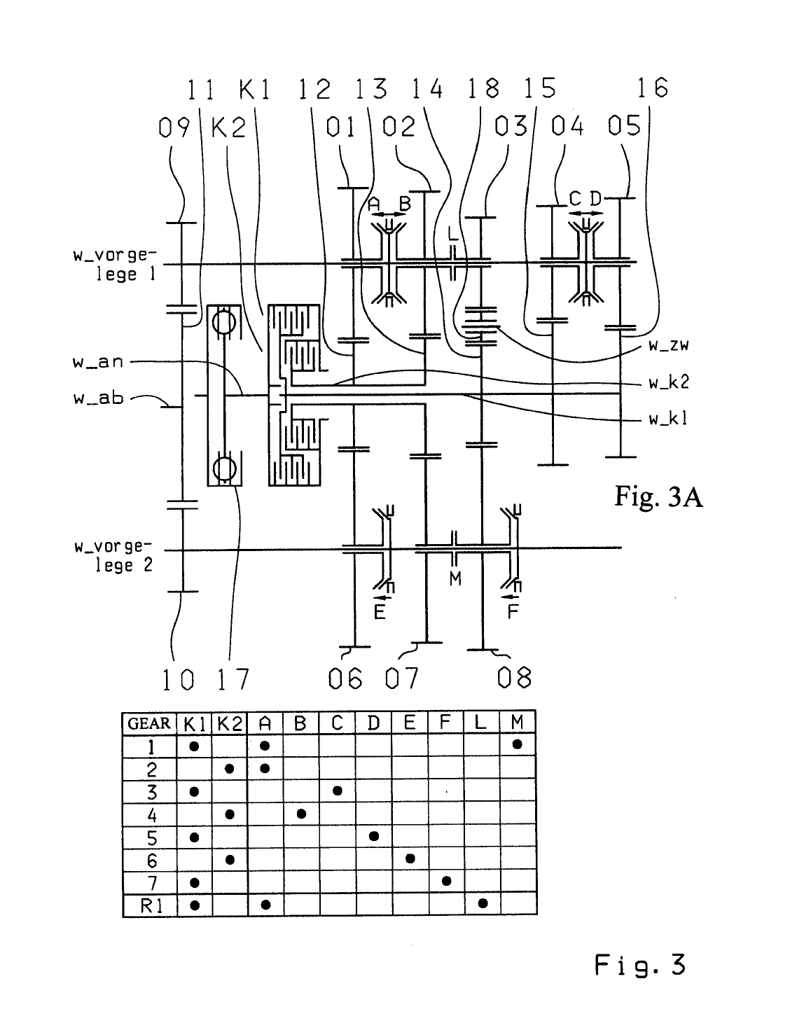

In the third embodiment, in accordance with FIG. 3, the five gear planes 01-06, 02-07, 03-08, 04-15, 05-16 are realized through two fixed gear wheels 12, 13 on the second transmission input shaft w_K2 and three fixed gear wheels 14, 15, 16, on the first transmission input shaft w_K1, which mesh with five idler gear wheels 01, 02, 03, 04, 05 on the first countershaft w_vorgelege 1 and with three idler gear wheels 06, 07, 08 of the second countershaft w_vorgelege 2.

In the shown embodiment in accordance with FIG. 3, the first gear plane 01-06, the second gear plane 02-07, and the third gear plane 03-08 are designed as dual gear planes. In contrary, the fourth gear plane 04-15 and the fifth gear plane 05-16 are each designed as single gear planes.

In the first gear plane 01-06, the fixed gear wheel 12 on the second transmission input shaft w_K2 meshes with the idler gear wheel 01 of the first countershaft w_vorgelege 1, and the idler gear wheel 06 on the second countershaft w_vorgelege 2. The second gear plane 02-07 comprises the fixed gear wheel 13 on the second transmission input shaft w_K2, which meshes with the idler gear wheel 02 on the first countershaft w_vorgelege 1, and the idler gear wheel 07 on the second countershaft w_vorgelege 2.

The third gear plane 03-08 comprises the fixed gear wheel 14 on the first transmission input shaft w_K1, which meshes with the idler gear wheel 08 on the a second countershaft w_vorgelege 2. In addition, the idler gear wheel 18 on an intermediate shaft w_zw meshes with the fixed gear wheel 14 on the first transmission input shaft w_K1, the idler gear wheel 03 on the first countershaft w_vorgelege 1. Hereby, a reversal of rotation can be provided to realize the reverse gear R1. It is also possible to design the idler gear wheel 18 as a step gear. Also, for the reversal of rotation, the idler gear wheel 03 on the first countershaft w_vorgelege 1 can mesh with the idler gear wheel 08 on the second countershaft w_vorgelege 2, so that, in this case, the idler gear wheel 18 can be omitted.

In the fourth gear plane 04-15, the fixed gear wheel 15 on the first transmission input shaft w_K1 meshes only with the idler gear wheel 04 on the first countershaft w_vorgelege 1. In the fifth gear plane 05-16, the fixed gear wheels 16 on the first transmission input shaft w_K1 also meshes only with the idler gear wheel 05 on the first countershaft w_vorgelege 1. Again, the advantage of a more free transmission gear selection arises, in contrast to gear planes with dual side idler gear wheel meshing at the fixed gear wheel.

In this proposed gear set configuration, a dual action coupling device A-B is positioned on the first countershaft w_vorgelege 1, between the first gear plane 01-06 and the second gear plane 02-07. In addition, the dual action coupling device C-D is positioned on the first countershaft w_vorgelege 1, between the fourth gear plane 04-15 and the fifth gear plane 05-16.

On the a second countershaft w_vorgelege 1, a single action coupling device E is positioned in the first gear plane 01-06, facing away from the clutches K1, K2. In addition, on the second countershaft w_vorgelege 2, a single action coupling device F is positioned in the third gear plane 03-08, facing away from the clutches K1, K2.

To realize winding-path gears, meaning to couple the two partial transmissions with each other, there is provided, beside the shifting device L, which is positioned on the first countershaft w_vorgelege 1, between the second gear plane 02-07 and the third gear plane 03-08, an additional shifting device between the second gear plane 02-07 and the third gear plane 03-08 on the second countershaft w_vorgelege 2.

The shown table in FIG. 3A presents an exemplary shifting scheme for the second embodiment of the 7-gear double clutch transmission.

In accordance with the shifting scheme in FIG. 3A, the first forward gear 1 is shifted via the first clutch K1 and via the coupling device A-B, shifted in the direction A, the activated shifting device M as a winding-path gear. The second forward gear 2 is realized via the second clutch K2 and via the coupling device A-B, shifted in the direction A, the third forward gear 3 is shifted via the clutch K1 and via the coupling device C-D, shifted in the direction C. The fourth forward gear 4 is again shifted via the second clutch K2 and via the coupling device A-B, shifted in the direction B, the fifth forward gear 5 is realized via the first clutch K1 and via the coupling device C-D, shifted in the direction D. The sixth forward gear 6 is shifted via the second clutch K2 and via the coupling device E of the second countershaft w_vorgelege 2, shifted in the direction E, the seventh forward gear 7 is shifted via the first clutch K1 and via the coupling device F of the second countershaft w_vorgelege 2. The reverse gear R1 is shifted via the first clutch K1 and via the coupling device A-B, shifted in the direction A, via the activated shifting element L as a winding-path gear.

Thus, the first forward gear 1 uses the gear wheels 14, 08, 07, 13, 12, 01, and 09. In the second forward gear 2, the gear wheels 12, 01, and 09 are used, whereby, for the realization of the third forward gear 3, the gear wheels 15, 04, and 09 are applied. In the fourth forward gear 4, the gear wheels 13, 02, and 09 are used, whereby in the fifth forward gear 5, the gear wheels 16, 05, and 09 are used, whereby the sixth forward gear 6 uses the gear wheels 12, 06, and 10. Finally, the seventh order gear 7 uses the gear wheels 14, 08, and 10 the reverse gear R1, as a winding-path gear, uses the gear wheels 14, 18, 03, 02, 13, 12, 01, and 09.

Other assignments for the particular gear steps, in regard to clutches, are also possible in this embodiment. Especially and for instance through a mirror image, a reversed assignment can easily be realized.

In the above described embodiments, the direction into which the coupling devices are shifted, to connect a particular idler gear wheel with the respective countershaft, can be altered by a modifying the coupling devices, for instance, through particular deflection devices.

### REFERENCE CHARACTERS

01 Idler gear wheel on the first Countershaft
02 Idler gear wheel on the first Countershaft
03 Idler gear wheel on the first Countershaft
04 Idler gear wheel on the first Countershaft
05 Idler gear wheel on the first Countershaft
06 Idler gear wheel on the second Countershaft
07 Idler gear wheel on the second Countershaft
08 Idler gear wheel on the second Countershaft
09 Fixed gear wheel on the first Countershaft as Output Stage
10 Fixed gear wheel on the second Countershaft as Output Stage
11 Fixed gear wheel on the Output Shaft
12 Fixed gear wheel on the second Transmission Input Shaft
13 Fixed gear wheel on the second Transmission Input Shaft
14 Fixed gear wheel on the first Transmission Input Shaft
15 Fixed gear wheel on the first Transmission Input Shaft
16 Fixed gear wheel on the first Transmission Input Shaft
17 Torsion Vibration Damper
K1 First Clutch
K2 Second Clutch
w_an Drive Shaft
w_ab Output Shaft
w_vorgelege 1 First Countershaft
w_vorgelege 2 Second Countershaft
A-B dual action Coupling Device
C-D dual action Coupling Device
E single action Coupling Device
F-G dual action Coupling Device
H additional Shifting Device
F single action Coupling Device
L Additional Shifting Device
M Additional Shifting Device
i Gear Transmission Ratio
phi Transmission Ratio Spread
1 First Forward Gear
2 Second Forward Gear
3 Third Forward Gear
4 Fourth Forward Gear
5 Fifth Forward gear
6 Sixth Forward Gear
7 Seventh Forward Gear
RA1 First Reverse Gear
RA2 Second Reverse Gear
RB1 alternative First Reverse Gear
R1 First Reverse Gear
R2 Second Reverse Gear
w_zw Intermediate Shaft
18 Idler gear wheel on the Intermediate Shaft

1-56. (canceled)

57. A double clutch transmission comprising:
first and second clutches (K1, K2) each comprising an input side connected to an input shaft (w_an) and an output side respectively connected to one of first and second transmission input shafts (w_K1, w_K2) arranged coaxially with one another;
at least first and second countershafts (w_vorgelege1, w_vorgelege2) rotatably supporting idler gear wheels (01, 02, 03, 04, 05, 06, 07, 08);
fixed gear wheels (12, 13, 14, 15, 16) being supported on each of the first and second transmission input shafts (w_K1, w_K2), in a rotationally fixed manner, and engaging with at least some of the idler gear wheels (01, 02, 03, 04, 05, 06, 07, 08);
a plurality of coupling devices (A-B, C-D, F-G, E, H, F) being supported on the first and the second countershafts (w_vorgelege1, vorgelege2), each of the plurality of coupling devices (A-B, C-D, F-G, E, H, F) connecting, in a rotationally fixed manner, an idler gear wheel (01, 02, 03, 04, 05, 06, 07) with one of the first and the second countershafts (w_vorgelege1, w_vorgelege2);
the first and the second countershafts (w_vorgelege1, w_vorgelege2) each comprising an output gear wheel pair (09, 10) which engages with gearing of an output shaft (w_ab), and at least one shifting device (L) for coupling the first and the second transmission input shafts (w_K1, w_K2) such that at least seven power shift forward gears (1, 2, 3, 4, 5, 6, 7) and at least one reverse gear (RA1, R1) are engagable and five gear planes (01-12, 01-06; 02-06, 02-07; 03-07, 03-14, 03-08; 04-15, 04-08; 05-16) are arranged such that at least one power shift winding-path gear is engagable via the at least one shifting device (L, M).

58. The double clutch transmission according to claim 57, wherein at least one of the power shift and non-power shift winding-path gears is at least one of an overdrive gear, an off-road gear, an intermediate gear, and an additional reverse gear.

59. The double clutch transmission according to claim 57, wherein at least one first forward gear (1) and one reverse gear (R2) are shiftable as power shift winding-path gears.

60. The double clutch transmission according to claim 57, wherein the five gear planes (01-12, 02-06, 03-07, 04-15, 05-16) are realized by two fixed gear wheels (12, 13) on the second transmission input shaft (w_K2), three fixed gear wheels (14, 15, 16) on the first transmission input shaft (w_K1), five idler gear wheels (01, 02, 03, 04, 05) on the first countershaft (w_vorgelege1) and two idler gear wheels (06, 07) on the second countershaft (w_vorgelege2).

61. The double clutch transmission according to claim 57, wherein a fixed gear wheel (12) on the second transmission input shaft (w_K2) engages with an idler gear wheel (01) on the first countershaft (w_vorgelege1) to form a first gear plane (01-12) the.

62. The double clutch transmission according to claim 57, wherein a fixed gear wheel (13) on the second transmission input shaft (w_K2) engages with an idler gear wheel (02) on the first countershaft (w_vorgelege1) and an idler gear wheel (06) on the second countershaft (w_vorgelege2) to form a second gear plane (02-06).

63. The double clutch transmission according to claim 57, wherein a gear wheel (14) on the first transmission input shaft (w_K1) engages with an idler gear wheel (03) on the first countershaft (w_vorgelege1) and an idler gear wheel (07) on the second countershaft (w_vorgelege2) to form a third gear plane (03-07).

64. The double clutch transmission according to claim 63, wherein an intermediate idler gear wheel (18), that engages with the idler gear wheel (07) on the second countershaft (w_vorgelege2), is supported on an intermediate shaft (w_zw).

65. The double clutch transmission according to claim 63, wherein the idler gear wheel (03) on the first countershaft (w_vorgelege1) engages with the idler gear wheel (07) on the second countershaft (w_vorgelege2).

66. The double clutch transmission according to claim 63, wherein the idler gear wheel (03, 18), which engages with the idler gear wheel (07) on the second countershaft (w_vorgelege2), is a step gear.

67. The double clutch transmission according to claim 57, wherein a fixed gear wheel (15) on the first transmission input shaft (w_K1) engages with an idler gear wheel (04) on the first countershaft (w_vorgelege1) to form a fourth gear plane (04-15).

68. The double clutch transmission according to claim 57, wherein a fixed gear wheel (16) on the first transmission input shaft (w_K1) engages with an idler gear wheel (05) on the first countershaft (w_vorgelege1) to form a fifth gear plane (05-16).

69. The double clutch transmission according to claim 57, wherein a dual action coupling device (A-B) is supported on the first countershaft (w_vorgelege1), between a first gear plane (01-12) and a second gear plane (02-06).

70. The double clutch transmission according to claim 57, wherein a dual action coupling device (C-D) is supported on the first countershaft (w_vorgelege1), between a third gear plane (03-07) and a fourth gear plane (04-15).

71. The double clutch transmission according to claim 57, wherein a single action coupling device (E) is supported on the first countershaft (w_vorgelege1) adjacent a fifth gear plane (05-16).

72. The double clutch transmission according to claim 57, wherein a dual action coupling device (F-G) is supported on the second countershaft (w_vorgelege2), between a second gear plane (02-06) and a third gear plane (03-07).

73. The double clutch transmission according to claim 57, wherein the at least one shifting device (L) is supported on the first countershaft (w_vorgelege1), between a second gear plane (02-06) and a third gear plane (03-07).

74. The double clutch transmission according to claim 57, wherein
a first forward gear (1) is engaged as a winding-path gear by engagement of the first clutch (K1) and the at least one shifting device (L) and shifting of a fourth coupling device (F-G) in a first direction (F);
a second forward gear (2) is engaged by engagement of the second clutch (K2) and shifting of the fourth coupling device (F-G) in the first direction (F);
a third forward gear (3) is engaged by engagement of the first clutch (K1) and shifting of a second coupling device (C-D) in a first direction (C);
a fourth forward gear (4) is engaged by engagement of the second clutch (K2) and shifting of a first coupling device (A-B) in a second direction (B);
a fifth forward gear (5) is engaged by engagement of the first clutch (K1) and shifting of the second coupling device (C-D) in a second direction (D);
a sixth forward gear (6) is engaged by engagement of the second clutch (K2) and shifting of the first coupling device (A-B) in a first direction (A);
a seventh forward gear (7) is engaged by engagement of the first clutch (K1) and a third coupling device (E) on the first countershaft (w_vorgelege1);
a first reverse gear (R1) is engaged by engagement of the first clutch (K1) and shifting of the fourth coupling device (F-G) in a second direction (G); and
a second reverse gear (R2) is engaged as a winding-path gear by engagement of the second clutch (K2) and the at least one shifting element (L) and shifting of the fourth coupling device (F-G) in the second direction (G).

75. The double clutch transmission according to claim 57, wherein at least one reverse gear (RA1, RA2, RA3) is shifted as a power shiftable winding-path gear.

76. The double clutch transmission according to claim 75, wherein the five gear planes (01-06, 02-07, 03-14, 04-08, 05-16) are achieved by two fixed gear wheels (12, 13) on the second transmission input shaft (w_K2), three fixed gear wheels (14, 15, 16) on the first transmission input point shaft (w_K2), five idler gear wheels (01, 02, 03, 04, 05) on the first countershaft (w_vorgelege1) and three idler gear wheels on the second countershaft (w_vorgelege2).

77. The double clutch transmission according to claim 75, wherein a fixed gear wheel (12) on the second transmission input shaft (w_K2) engages with an idler gear wheel (01) on the first countershaft (w_vorgelege1) and an idler gear wheel (06) on the second countershaft (w_vorgelege2) to form a first gear plane (01-06).

78. The double clutch transmission according to claim 75, wherein a fixed gear wheel (13) on the second transmission input shaft (w_K2) engages with an idler gear wheel (07) on the second countershaft (w_vorgelege2), and an idler gear wheel (18) engages with the fixed gear wheel (13) on the second transmission input shaft (w_K2) and with an idler gear wheel (02) on the first countershaft (w_vorgelege1) to form a second gear plane (02-07).

79. The double clutch transmission according to claim 78, wherein the idler gear wheel (18), which engages with the idler gear wheel (02) on the first countershaft (w_vorgelege1), is supported on an intermediate shaft (w_zw).

80. The double clutch transmission according to claim 78 wherein the idler gear wheel (02) on the first countershaft (w_vorgelege1) engages with the idler gear wheel (07) on the second countershaft (w_vorgelege2).

81. The double clutch transmission according to claim 78, wherein the idler gear wheel (07, 18), which engages with the idler gear wheel (02) on the first countershaft (w_vorgelege1), is a step gear.

82. The double clutch transmission according to claim 75, wherein a fixed gear wheel (14) on the first transmission input shaft (w_K1) engages with an idler gear wheel (03) on the first countershaft (w_vorgelege1) to form a third gear plane (03-14).

83. The double clutch transmission according to claim 75, wherein a fixed gear wheel (15) on the first transmission input shaft (w_K1) engages with an idler gear wheel (04) on the first countershaft (w_vorgelege1) and an idler gear wheel (08) on the second countershaft (w_vorgelege2) to form a fourth gear plane (04-08).

84. The double clutch transmission according to claim 75, wherein a fixed gear wheel (16) on the first transmission input shaft (w_K1) engages with an idler gear wheel (05) on the first countershaft (w_vorgelege1) to form a fifth gear plane (05-16).

85. The double clutch transmission according to claim 75, wherein a dual action coupling device (A-B) is supported on the first countershaft (w_vorgelege1) between a first gear plane (01-06) and a second gear plane (02-07).

86. The double clutch transmission according to claim 75, wherein a dual action coupling device (C-D) is supported on the first countershaft (w_vorgelege1) between a third gear plane (03-14) and a fourth gear plane (04-08).

87. The double clutch transmission according to claim 75, wherein a single action coupling device (E) is supported on the first countershaft (w_vorgelege1), in a fifth gear plane (05-16).

88. The double clutch transmission according to claim 75, wherein a dual action coupling device (F-G) is supported on the second countershaft (w_vorgelege2) between a first gear plane (01-06) and a second gear plane (02-07).

89. The double clutch transmission according to claim 75, wherein a single action coupling device (H) is supported adjacent a fourth gear plane (04-08).

90. The double clutch transmission according to claim 75, wherein the at least one device (L) is supported on the first countershaft (w_vorgelege1) between a second gear plane (02-07) and a third gear plane (03-14).

91. The double clutch transmission according to claim 75, wherein
a first forward gear (1) is engaged by engagement of the first clutch (K1) and shifting of a second coupling device (C-D) in a first direction (C);
a second forward gear (2) is engaged by engagement of the second clutch (K2) and shifting of a first coupling device (A-B) in a first direction (A);
a third forward gear (3) is engaged by engagement of the first clutch (K1) and shifting of a second coupling device (C-D) in a second direction (D);
a fourth forward gear (4) is engaged by engagement of the second clutch (K2) and shifting of a fourth coupling device (F-G) in a second direction (G);
a fifth forward gear (5) is engaged by engagement of the first clutch (K1) and shifting of a third coupling device (E) on the first countershaft (w_vorgelege1);
a sixth forward gear (6) is engaged by engagement of the second clutch (K2) and shifting of the fourth coupling device (F-G) in a first direction (F);
a seventh forward gear (7) is engaged by engagement of fifth coupling device (H) on the second countershaft (w_vorgelege2);
a first reverse gear (RA1) is engaged as a winding-path gear by engagement of the first clutch (K1) and the at least one shifting device (L) and shifting of the first coupling device (A-B) in the first direction (A); and
a second reverse gear (RA2, RB1) is engaged by engagement of the second clutch (K2) and shifting of the first coupling device (A-B) in a second direction (B).

92. The double clutch transmission according to claim 57, wherein at least one first forward gear (1) is power shifted as a winding-path gear.

93. The double clutch transmission according to claim 92, wherein the five gear planes (01-06, 02-07, 03-08, 04-15, 05-16) are achieved by two fixed gear wheels (12, 13) on the second transmission input shaft (w_K2) and three fixed gear wheels (14, 15, 16) on the first transmission input shaft (w_K1), five idler gear wheels (01, 02, 03, 04, 05) on the first countershaft (w_vorgelege1) and three idler gear wheels (06, 07, 08) on the second countershaft (w_vorgelege2).

94. The double clutch transmission according to claim 92, wherein a fixed gear wheel (12) on the second transmission input shaft (w_K2) engages with an idler gear wheel (01) on the first countershaft (w_vorgelege1) and an idler gear wheel (06) on the second countershaft (w_vorgelege2) to form a first gear plane (01-06).

95. The double clutch transmission according to claim 92, wherein a fixed gear wheel (13) on the second transmission input shaft (w_K2) engages with an idler gear wheel (02) on the first countershaft (w_vorgelege1) and an idler gear wheel (07) on the second countershaft (w_vorgelege2) to form a second gear plane (02-07).

96. The double clutch transmission according to claim 92, wherein a fixed gear wheel (14) on the first transmission input shaft (w_K1) engages with an idler gear wheel (08) on the second countershaft (w_vorgelege2), and the fixed gear wheel (14) on the first transmission input shaft (w_K1) also engages with an idler gear wheel (18) and an idler gear wheel (03) on the first countershaft (w_vorgelege1) to form a third gear plane (03-08).

97. The double clutch transmission according to claim 96, wherein the idler gear wheel (18), which engages with the idler gear wheel (03) on the first countershaft (w_vorgelege1), is supported on an intermediate shaft (w_zw).

98. The double clutch transmission according to claim 92, wherein the idler gear wheel (03) on the first countershaft (w_vorgelege1) engages with the idler gear wheel (08) on the second countershaft (w_vorgelege2).

99. The double clutch transmission according to claim 97, wherein the idler gear wheel (08, 18), which engages with the idler gear wheel (03) on the first countershaft (w_vorgelege1), is a step gear.

100. The double clutch transmission according to claim 92, wherein a fixed gear wheel (15) on the first transmission input shaft (w_K1) engages with an idler gear wheel (04) on the first countershaft (w_vorgelege1) to form a fourth gear plane (04-16).

101. The double clutch transmission according to claim 92, wherein a fixed gear wheel (16) of the first transmission input shaft (w_K1) engages with an idler gear wheel (05) on the first countershaft (w_vorgelege1) to form a fifth gear plane (05-16).

102. The double clutch transmission according to claim 92, wherein a dual action coupling device (A-B) is supported by the first countershaft (w_vorgelege1) between a first gear plane (01-06) and a second gear plane (02-07).

103. The double clutch transmission according to claim 92, wherein a dual action coupling device (C-D) is supported by the first countershaft (w_vorgelege1) between a fourth gear plane (04-15) and a fifth gear plane (05-16).

104. The double clutch transmission according to claim 92, wherein a single action coupling device (E) is supported by the second countershaft (w_vorgelege2) in a first gear plane (01-06).

105. The double clutch transmission according to claim 92, wherein a single action coupling device (F) is supported by the second countershaft (w_vorgelege2) adjacent a third gear plane (03-08).

106. The double clutch transmission according to claim 92, wherein the at least one shifting device (L) is supported on the first countershaft (w_vorgelege1) between a second gear plane (02-07) and a third gear plane (03-08).

107. The double clutch transmission according to claim 92, wherein the at least one shifting device (M) is supported on the second countershaft (w_vorgelege2) between a second gear plane (02-07) and a third gear plane (03-08).

108. The double clutch transmission according to claim 97, wherein either one coupling device (E) and the at least one shifting device (M) or another coupling device (F) and the at least one shifting device (M) are double side coupling devices.

109. The double clutch transmission according to claim 92, wherein
a first forward gear (1) is engaged as a winding-path gear by engagement of the first clutch (K1) and the at least one shifting device (M) and shifting of a first coupling device (A-B) in a first direction (A);
a second forward gear (2) is engaged by engagement of the second clutch (K2) and shifting of the first coupling device (A-B) the first direction (A);
a third forward gear (3) is engaged by engagement of the first clutch (K1) and shifting of a second coupling device (C-D) in a first direction (C);
a fourth forward gear (4) is engaged by engagement of the second clutch (K2) and shifting of the first coupling device (A-B) in a second direction (B);
a fifth forward gear (5) is engaged by engagement of the first clutch (K1) and shifting of the second coupling device (C-D) in a second direction (D);
a sixth forward gear (6) is engaged by engagement of the second clutch (K2) and a coupling device (E) on the second countershaft (w_vorgelege2);
a seventh forward gear (7) is engaged by engagement of the first clutch (K1) and a coupling device (F) on the second countershaft (w_vorgelege2); and
a reverse gear (R1) is engaged as a winding-path gear by engagement of the first clutch (K1) and the at least one shifting device (L) and shifting of the first coupling device (A-B) in the first direction (A).

110. The double clutch transmission according to claim 57, wherein the drive shaft (w_an) and the output shaft (w_ab) are not coaxial with respect to each other.

111. The double clutch transmission according to claim 57, wherein an integrated output stage comprises a fixed gear wheel (11) on the output shaft (w_ab), which engages with a fixed gear wheel (09) on the first countershaft (w_vorgelege1) and a fixed gear wheel (10) on the second countershaft (w_vorgelege2).

112. The double clutch transmission according to claim 57, wherein lower gears and the reverse gears are shifted by either one of the first and the second clutches (K1, K2), which function as one of a starting clutch and a gear shift clutch.
